(19) United States
(12) Patent Application Publication
(10) Pub. No.: US 2026/0318720 A1
(43) Pub. Date: Oct. 15, 2026

(54) INDUCTIVELY AND OPTICALLY EVALUATED MOVABLE ELEMENT OF A POSITION SENSOR

(71) Applicant: HELLA GMBH & CO. KGAA, Lippstadt (DE)

(72) Inventors: Henning Irle, Lippstadt (DE); Christoph Wostmann, Lippstadt (DE)

(21) Appl. No.: 19/688,941

(22) Filed: May 27, 2026

Related U.S. Application Data
(63) Continuation of application No. PCT/EP2024/082684, filed on Nov. 18, 2024.

(30) Foreign Application Priority Data
Nov. 28, 2023 (DE) 102023133193.0

(51) Int. Cl. G01D 5/56; G01D 5/20; G01D 5/58

(52) U.S. Cl. CPC G01D 5/56; G01D 5/2053; G01D 5/58

(57) ABSTRACT

The present invention relates to a movable element for a position sensor, in particular for a steer-by-wire system for a vehicle. The movable element includes: at least one wing for inductively detecting the position of the movable element; and a measurement device based on a further physical measurement principle for detecting the position of the movable element.

### CROSS-REFERENCE TO RELATED APPLICATIONS

This application is a continuation of PCT/EP 2024/082684, filed Nov. 18, 2024, which claims priority to German Patent Application DE 10-2023-133-193.0, filed Nov. 28, 2023, the disclosures of which are incorporated by reference in their entirety.

### FIELD OF THE INVENTION

The invention relates to a movable element, a position sensor, a method, a computer program product, a computer-readable data carrier, a control unit, and a vehicle.

### BACKGROUND OF THE INVENTION

Inductive position sensors, which operate on the physical measurement principle of induction, are well known. Said inductive position sensors can be used, for example, to determine the (rotational) position, in particular the angle, of an axis of rotation. This can be relevant, for example, in a vehicle steering system, such as a steer-by-wire system.

The state of the art has disadvantages. Inductive position sensors (and also other known position sensors) can, at least theoretically, be subject to common cause failures (wherein this can affect the functionality of the position sensor in particular), which can be traced back to a common cause. For example, strong electric and/or magnetic fields can influence an (inductive) position sensor, wherein said position sensor functions at least less well.

### SUMMARY OF THE INVENTION

It is therefore an object of the present invention to at least partially overcome at least one of the disadvantages described above. In particular, it is the object of the invention to provide a more robust position sensor which preferably delivers better, more reliable and/or more robust measurement results. The availability of the position sensor for position detection can be extended, in particular statistically, wherein said position sensor preferably enables continuous position detection, advantageously even under (strong) external common cause failures. It can therefore be an object to increase safety. It can also be an object to provide improved error detection and/or improved validation of position sensors and their sensor data.

The above object is achieved by a movable element, a position sensor, a method, a computer program product, a computer-readable data carrier, a control unit, and a vehicle. Further features and details of the invention are apparent from the description and the drawings. Features and details described in connection with the movable element according to the invention naturally also apply in connection with the position sensor according to the invention and/or in connection with the method according to the invention and/or in connection with the computer program product according to the invention and/or in connection with the computer-readable data carrier according to the invention and/or in connection with the control unit according to the invention and/or in connection with the vehicle according to the invention and vice versa, so that, with regard to the disclosure of the individual aspects of the invention, mutual reference is always made or can be made. In particular, advantages described in the context of the first, second, third, fourth, fifth, sixth and/or seventh aspect also apply in each case to the first, second, third, fourth, fifth, sixth and/or seventh aspect.

The above object is achieved according to a first aspect by a movable element for a position sensor, in particular for a steer-by-wire system for a vehicle, having: an inner ring comprising at least one wing for inductively detecting the position of the movable element; and a measurement device based on a further physical measurement principle for detecting the position of the movable element.

The movable element, the position sensor, the method, the computer program product, the computer-readable data carrier, the control unit and/or the vehicle can be specially designed for use with a steer-by-wire system, pedal (e.g. accelerator pedal, brake pedal, clutch), X-by-wire system and/or break-by-wire system.

Particularly preferably, at least two, preferably different, physical measurement principles can be combined in one (preferably only one) movable element and/or sensor, in particular a position sensor. In particular, the measurement device can enable an (additional) other (in particular different) physical measurement principle than inductive position detection. This can at least partially reduce the above disadvantages. In particular, the influence of common cause failures can be reduced and/or completely prevented. It can therefore be prevented that (in the worst case) a position detection fails completely. This can enable position detection that is not only “fail-safe” (e.g. in the case of power steering, only the assistance switches off in the event of failure, while the driver can still continue to steer), but is advantageously “fault-tolerant” and/or “fail-operational” (wherein preferably, for example, in a steer-by-wire system, further operation can be guaranteed even if at least one position detection fails). Preferably, if position detection by a physical measurement method fails, at least one other, preferably different, physical measurement method can continue to enable position detection.

It may preferably be provided that the inductive position detection and/or the measurement device for position detection are designed with at least double redundancy via a further physical measurement principle. It may therefore be provided that at least two measurement devices are provided. It may be provided that at least two wings and/or two induction detecting elements are provided. Preferably, the redundant components are independent of each other and/or maximally (geometrically) spaced (e.g. along the circumference) so that the failure of one also leads to a failure of the other with minimum probability. For example, it may be provided that opposite wings are used and/or the induction detecting elements are arranged opposite each other, in particular in relation to the movable element.

It is therefore particularly preferable that no (spatially) separate or separate (position) sensors are required for different physical measurement principles. Different physical measurement principles can be integrated into or realized by a moving element and/or sensor. One example can be a movable element (see below), which enables both inductive detection and optical detection. This also enables a smaller installation space and/or a lower weight.

The inner and/or outer ring can be designed to be substantially flat and/or planar. Said ring can have an outer and/or inner round outer shape. In the simplest case, it can therefore be a disk, preferably with a central hole in the middle. It may be provided that the inner ring can be arranged centrally on a (central) axis of rotation in order to enable position detection, in particular of the (rotation) angle of the axis of rotation. For example, this can be an axis of rotation of a steer-by-wire system, e.g. on the steering wheel (in particular the steering axle), in or on the gearbox, on the engine and/or the lifting rod (in a vehicle). During operation, the ring can rotate, in particular in a non-rotating manner with an axis of rotation coupled thereto. Moving the ring or the movement of the ring can be determined as part of a position detection, preferably via the at least one wing that is coupled to the inner and/or outer ring, in particular fixedly coupled. The inner and/or outer ring can extend substantially in an x-y plane (wherein in particular the x, y and z directions can form a right-handed system). The inner and/or outer ring can have a thickness (along the z-direction) of between 0.01 and 100 mm, preferably between 0.1 and 10 mm, preferably between 0.3 and 6 mm, particularly preferably between 0.5 and 4 mm, ideally between 1 and 2 mm. The movable element and/or the inner and/or outer ring can have a diameter, in particular perpendicular to the z-direction along an x-direction and/or y-direction, of between 1 to 200 mm, preferably between 10 to 100 mm, preferably between 20 to 80 mm, particularly preferably between 30 to 70 mm, ideally between 40 to 60 mm.

The inner and/or outer ring and/or the at least one wing can have a conductive material in order to advantageously enable a displacement of electrical charge for inductively detecting the position. In particular, eddy currents can be induced in the inner ring and/or the at least one wing, which can be detected by an induction detecting element. Preferably, the inner and/or outer ring and/or the at least one wing comprise a metal, for example sheet metal (easy to form), stainless steel (especially durable) and/or copper (especially highly conductive). The inner and/or outer ring and/or the at least one wing can form a coherent component and preferably be manufactured from one, in particular coherent, stamped part. These can therefore preferably be punched out of one material. Accordingly, the inner and/or outer ring and/or the at least one wing can form a stamped part and/or stamped-bent part, which enables particularly favorable, simple, fast and/or robust manufacturing. It may also be provided to provide openings and/or wing gaps in this manner. In a particularly advantageous way, two or all different physical measurement principles can be made possible in one and/or by one movable element and/or one sensor.

The at least one wing, in particular all wings, can be arranged on the inner and/or outer ring, in particular connected by a material bond. Accordingly, the wing can be arranged at the outermost circumferential edge of the inner ring, and in particular represent a sectional extension of the inner ring, in particular in the x-y plane, with increasing distance from the center point/point of symmetry. In this case, the at least one wing, in particular due to its (geometric design), can enable an inductive measurement, advantageously due to a periodic approach and/or spacing (by a rotation) of the inner ring and/or the wing, in particular in relation to a (complementary) induction detecting element, which is preferably stationary, for example further (radially) outside and/or located below or above it (in another plane). The wing can have the same thickness as the inner and/or outer ring. The wing can have a width, in particular perpendicular to the z-direction along an x-direction and/or y-direction, of between 0.1 and 200 mm, preferably between 0.5 and 50 mm, preferably between 1 and 25 mm, particularly preferably between 3 and 20 mm, ideally between 5 and 15 mm. A larger width can provide a stronger (induced) sensor signal. A smaller width can allow a smaller installation space and/or reduced weight. The outer shape of at least one wing (maximum distance to the center point of the inner ring) can be designed to be circular. The inner ring, the outer ring, the at least one wing and/or all wings can be hollow or form a hollow space in order to advantageously save weight and/or material.

An induction detecting element can be provided, which has a transmitting coil (30a in FIGS. 5 and 6, dashed circle) and at least one receiving coil (30b in FIGS. 5 and 6, diagonally hatched). The transmitting coil and/or the receiving coil can be manufactured to be planar, in particular in one layer and/or several layers of a printed circuit board (PCB). Said coils preferably do not rotate with the other components shown and/or can be arranged separately, e.g. in a plane located below or above, in particular in a printed circuit board. Preferably, the transmitting coil can emit a transmitting signal, e.g. a high-frequency electromagnetic wave, which induces an eddy current in at least one, preferably all, wings. The transmitting coil can be designed to be circular and/or spiral-shaped, in particular perpendicular to an axis of rotation. The eddy current(s) can be detected accordingly by the receiving coil (e.g. inductively). This allows a measurement signal to be measured which is dependent on the (angular) position of the wing(s). The (angular) position can be determined from the measurement signal. It may be provided that the outer ring has at least one slot. The slot can form a complete interruption in the material of the outer ring. As a result, eddy currents generated by the induction detecting element, in particular a transmitting coil, cannot flow (at this point) in the outer ring, which in particular enables a more accurate measurement, since the eddy currents advantageously flow only or primarily in the wings and not in the (otherwise continuous) outer ring. It may be provided that the slot only partially interrupts the width of the outer ring (particularly in the radial direction). This allows eddy currents to be at least partially prevented, while at the same time the remaining part of the outer ring still provides good mechanical stability. As a result, the distance of the current path of the eddy currents can be at least further away from the induction detecting element, in particular the receiving coil, which can in particular enable a more precise measurement and thus determination of the (angular) position of the at least one wing. The at least one wing, the inner ring, the outer ring and/or the at least one measurement device can rotate, in particular about a point of symmetry, which can, for example, be located substantially in the center of the arrangement and/or (centrally) on the axis of rotation. A rotary fastening can be present on a, in particular central, axis of rotation, for example along the circumference of the axis of rotation. In other words, it can be an internal rotor, in particular with internal axle coupling. The induction detecting element can preferably remain stationary, in particular during rotation, i.e. it does not rotate. In this way, inductive measurement can be made possible by rotating the wings, as the induction detecting element does not rotate along. It may also be provided that the outer ring, in particular at least in sections, preferably in the radial direction towards the outside, has a rotary fastening, for example with a motor and/or a gear. In other words, it can be an external rotor, in particular with hollow axle coupling. For example, a bearing can be provided on the outside. It is also possible that the outer ring merely forms an extension of at least one wing. In other words, the at least one slot can be designed to be so large that sections of the outer ring cover the at least one wing, making it appear in particular as if there is no outer ring. In other words, a design that can be realized without an outer ring (and/or inner ring) is also conceivable. In other words, it may be provided that the inner ring and/or outer ring are very narrow or not provided (infinitely or infinitesimally narrow). For example, the outer ring can be omitted and the at least one wing can be arranged only on the inner ring. It is also conceivable that the outer ring has at least one slot or a plurality of slots, and that the material of the outer ring is substantially radially flush with the at least one wing (so that it looks in particular as if there were no outer ring, see above). It is also conceivable that the inner ring is omitted and that at least one wing is directly connected (e.g. welded on) to an axis of rotation. In this case, the outer ring may or may not be provided (see above). Preferably, the at least one wing, the inner ring, and/or the outer ring can (still) enable measurement using at least two different measurement principles. The slot can have a width, in particular in the circumferential direction of the outer ring, of between 0.00001 and 100 mm, preferably between 0.0001 and 10 mm, preferably between 0.001 and 1 mm, preferably between 0.005 and 0.7 mm, particularly preferably between 0.01 and 0.3 mm, ideally between 0.05 and 0.15 mm. Preferably, the number of slots corresponds to the number of wings. It is particularly preferable for the slots to be arranged symmetrically, in particular centrally, between two wings. It may be provided to provide a greater thickness for the outer ring, the inner ring and/or at least one wing if at least one slot is provided. This allows sufficient and/or improved stability to be achieved. It may also be provided that the outer ring is reinforced, in particular in sections, preferably close to the at least one slot.

The measurement device can, in particular due to the (geometric design), enable a position detection, advantageously due to a periodic approach and/or spacing (by a rotation) of the inner ring, the outer ring and/or the wing, in particular in relation to a (complementary) counter-measurement device, which is preferably stationary. As a result, a corresponding further sensor signal can be provided by the measurement device and/or the counter-measurement device, which is provided to the control unit, for example via a data connection. The measurement device can be arranged in the inner ring, the outer ring and/or the at least one wing.

The further physical measurement principle of the measurement device can preferably differ from that of inductive position detection. Preferably, the further physical measurement principle can therefore be non-inductive or at least not primarily inductive (see below). This makes it possible to achieve a particularly high level of robustness, as a common cause failure is therefore unlikely to affect both and/or all physical measurement principles. Accordingly, functionality of the movable element and/or position sensor can always be enabled.

It may be provided that the further physical measurement principle (or the measurement device) enables emergency operation and/or fallback operation, and in particular is designed for this purpose. This can advantageously be used to carry out inductive position detection in normal operation and, in the event of a fault, in particular if the inductive position detection becomes inaccurate and/or fails, to achieve position detection (only) by the measurement device. A reduced resolution (e.g. of the angular position) can also be used in order to advantageously reduce complexity, costs, installation space and/or weight. It may also be possible to use a reduced resolution, which is noticeable to the driver for example through reduced driving comfort and/or steering behavior, as information for the driver and/or a control unit. Accordingly, the failure and/or malfunction of the (primary) inductive position detection can be communicated, for example in order to visit a repair shop.

It may be provided to use an inductive position detection and a position detection by the measurement device, in particular in parallel (or simultaneously). This allows plausibility checks and/or validation of the other physical measurement method to be achieved. This can improve the accuracy, robustness, reliability and/or speed of the position determination.

Within the scope of the invention, it may be advantageous for the movable element to have an inner and/or outer ring on which the at least one wing (12) is arranged, wherein in particular the outer ring surrounds the inner ring at least in sections, wherein preferably the outer ring has an insulator, in particular a plastic. It may be provided that the outer ring has at least one slot in order to advantageously prevent and/or reduce eddy currents in the outer ring, in particular in relation to the entire circumference. Preferably, several slots can be provided. The slots can preferably be distributed symmetrically, in particular in relation to the circumference. Preferably, a slot can be located substantially between two wings, in particular in a wing gap. Advantageously, a (parasitic) eddy current can be prevented in the outer ring, in particular between adjacent wings. Advantageously, at least one slot (in particular all slots) can be at least partially filled and/or reinforced with a plastic material in order to advantageously increase the mechanical stability, which can be reduced in particular by using a slot in the outer ring, which preferably comprises stainless steel. The at least one slot can completely or at least partially interrupt the outer ring. In the case of a complete interruption, eddy currents can be completely prevented at this location. In the case of a partial interruption, eddy currents can be at least partially prevented at this location, but at the same time the mechanical stability can be (comparatively) increased.

The outer ring can be circular in shape and, in particular, can be arranged at least partially between the wings in the wing gaps. This allows the movable element to be circular in shape, in particular when viewed from above along the z-direction. In other words, the outer ring can close the holes created by the wing gaps to complete a circular shape. In this respect, the outer ring can be flush with the at least one wing. This can be advantageous in order to position the measurement device at least partially at the height of the wings, in particular by simultaneously providing spatial, electrical and/or material separation. Alternatively or additionally, it may be provided that the outer ring extends the diameter of the movable element, and in particular protrudes beyond the wings. This can enable the measurement device to determine the position at (even) more external positions of the movable element (e.g. in relation to the center point and/or symmetry point). This allows a more precise separation of the physical measurement principles. This can also enable (mechanical) protection of the inner ring. This allows for integrated manufacturing, which optimizes the installation space and/or combines at least two different physical measurement principles. Preferably, no eddy current is induced in the at least one wing gap and/or the wing gaps.

The outer ring can have an insulator, in particular a plastic, at least in sections. An isolator can prevent weakening (e.g. signal attenuation) of the inductive position detection. It may also be provided that said isolator has materials with defined electrical properties, in particular a dielectric and/or a permittivity, in order to improve the inductive position detection, for example by advantageously influencing (in particular amplifying) the electric and/or magnetic fields. It may be provided that the outer ring is provided as a plastic back-molded component or is generated by a plastic injection molding process. In this case, the inner ring and/or the at least one wing can be back-molded and/or overmolded, in particular with plastic. Alternatively or additionally, it may be provided that conductive structures are arranged on the inner ring and/or at least one wing, for example by means of lamination, bonding and/or a non-positive connection. This allows for greater flexibility in the design. It may be provided that the inner ring, the outer ring and/or the at least one wing are integrated on a printed circuit board, wherein in particular the at least one opening and/or the at least one reflector are realized directly on the printed circuit board. Thus, simple, precise and/or cost-effective manufacturing can be advantageously achieved.

Within the scope of the invention, it is conceivable that the measurement device has at least one optical path for optical position detection of the movable element, wherein preferably the at least one optical path is arranged at least partially in the inner ring, in the at least one wing and/or in the outer ring, wherein in particular the optical path has at least one opening and/or a reflector.

In this case, an optical path for optical position detection may, in particular, comprise a path for light in a light barrier. Accordingly, the movable element and/or the position sensor can have at least one light barrier, for example a fork light barrier and/or reflex light barrier. Optical position detection can be achieved, for example, through the interaction of a light source (e.g. comprised on one side of a position sensor) and/or a light detector (e.g. comprised on a substantially opposite side of the position sensor). Light can be alternately, in particular periodically, measured and not measured by a light detector, preferably depending on the (rotational) position and/or the angle of the movable element. This can be made possible by at least one opening and/or a reflector. Optical position detection can be used as an additional, different and/or redundant physical measurement method. This can be particularly advantageously in improving the robustness of a moving element and/or position sensor, in particular as there are little or no common cause failures that can affect both the optical and inductive measurement principles.

An opening can comprise a material recess (preferably continuous in relation to the thickness). An opening can provide optical permeability, in particular for light. Accordingly, the optical path between the light source and the light sensor can be released through the opening, in particular periodically and/or upon rotation, so that the light sensor can receive the light emitted by a light source. If the opening is not at the same height or on the connecting line between the light source and the light sensor, no light or only very attenuated light can be detected by the light sensor. As a result, a corresponding further sensor signal can be provided by the light sensor, which is provided to the control unit, for example via a data connection. The light source can be arranged on one side (e.g. at the top or bottom in the z-direction) of the moving element, and the light sensor on the other side (e.g. at the bottom or top in the z-direction). This can enable a particularly robust and/or accurate measurement. The opening can have a width (in particular along the direction of rotation and/or the azimuth, e.g. of the inner ring) of between 0.1 and 100 mm, preferably between 0.01 and 10 mm, preferably between 0.1 and 5 mm, preferably between 0.5 and 4 mm, particularly preferably between 0.7 and 3 mm, ideally between 1 and 2 mm. The opening can have a height (in particular along the diameter and/or a radial coordinate, e.g. of the inner ring) of between 0.00001 and 100 mm, preferably between 0.0001 and 10 mm, preferably between 0.001 and 1 mm, preferably between 0.005 and 0.7 mm, particularly preferably between 0.01 and 0.3 mm, ideally between 0.05 and 0.15 mm. This means that the statistically frequently occurring dust particles with a size of around 1 mm cannot clog the opening, or at least only with difficulty. Contamination can therefore be prevented and/or reduced. It may be provided that a smaller opening allows a more accurate measurement. In this context, it may be provided that a larger opening enables a less accurate measurement, in particular resolution, which can advantageously provide a changed steering behavior (of a steer-by-wire system) for a driver, in particular to enable feedback (or an indication) of a malfunction, for example when the optical path is used during emergency operation. Preferably, the movable element and/or the position sensor has at least one light barrier, in particular a fork light barrier, in order to carry out optical position detection via at least one opening and/or the openings. Preferably, at least two fork light barriers are provided, which are spaced apart from each other, in particular at maximum distance, in order to enable a low susceptibility to errors. The wavelength range can be designed in such a way that external light, e.g. sunlight and the like, has little or no effect on the measurement.

It may be provided to provide at least two openings, in particular at least 16 openings, preferably at least 32 openings, advantageously at least 64 openings, particularly preferably at least 128 openings, ideally at least 256 openings. A larger number can enable additional redundancy, which advantageously increases robustness, reduces susceptibility to errors and/or increases accuracy. In this context, a total of 256 openings can represent a particularly advantageous compromise between the aforementioned advantages and the complexity of manufacturing and/or the device. It may be provided to arrange the openings substantially next to each other, e.g. next to each other in the at least one wing, in order to enable a small installation space, in particular for the required light sources and/or light sensors. It may also be provided to maximize the distance between the openings, e.g. distributed over different wings and/or the outer ring, in order to optimize robustness, optimize measurement accuracy and/or reduce susceptibility to errors. Advantageously, the openings and/or reflectors are distributed in such a way that at least one opening, in particular in conjunction with a light sensor, always generates an (optical) measurement signal. This can be achieved, for example, by a calibrated (angular) offset between openings (or reflectors) and/or light sensors. The arrangement of the openings means that the (optical) sensor signal can also be coded, i.e. in particular have a characteristic curve, which can be used advantageously to check the functionality and/or for unambiguous assignment (e.g. to prevent ambiguities).

A reflector can be configured to at least partially reflect light. Accordingly, the optical path between the light source and the light sensor can be released by the reflector, in particular periodically and/or on rotation, so that the light sensor can receive the light emitted by a light source. If the reflector is not located at the height of the light source and/or light sensor, no light or only a very attenuated light can be detected by the light sensor. As a result, a corresponding further sensor signal can be provided by the light sensor, which is provided to the control unit, for example via a data connection. The light source and the light sensor can be arranged at substantially the same position, in particular adjacent to each other. Advantageously, an arrangement on one side (e.g. at the top or bottom in the z-direction) of the movable element may be sufficient, which can advantageously reduce the installation space. The reflector can have a width (in particular along the direction of rotation and/or the azimuth, e.g. of the inner ring) of between 0.1 and 100 mm, preferably between 0.01 and 10 mm, preferably between 0.1 and 5 mm, preferably between 0.5 and 4 mm, particularly preferably between 0.7 and 3 mm, ideally between 0.9 and 2.0 mm. The reflector can have a height (in particular along the diameter and/or a radial coordinate, e.g. of the inner ring) of between 0.1 and 100 mm, preferably between 0.01 and 10 mm, preferably between 0.1 and 5 mm, preferably between 0.5 and 4 mm, particularly preferably between 0.7 and 3 mm, ideally between 0.9 and 20 mm. This means that the statistically frequently occurring dust particles with a size of around 0.1 mm cannot, or at least not completely, cover the reflector. This allows a particularly high level of robustness to be achieved. Greater expansion can prevent and/or reduce contamination or its influence. It may be provided that a smaller reflector enables a more accurate measurement. In this context, it may be provided that a smaller reflector enables a less accurate measurement, in particular resolution, which can advantageously provide a changed steering behavior (of a steer-by-wire system) for a driver, in particular to enable feedback (or an indication) of a malfunction, for example when the optical path is used during emergency operation. Preferably, the movable element and/or the position sensor has at least one light barrier, in particular a reflex light barrier, in order to carry out optical position detection via a reflector and/or the reflectors. Preferably, at least two reflex light barriers are provided, which are spaced apart from each other, in particular at maximum distance, in order to enable a low susceptibility to errors.

It may be provided to provide at least two reflectors, in particular at least 16 reflectors, preferably at least 32 reflectors, advantageously at least 64 reflectors, particularly preferably at least 128 reflectors, ideally at least 256 reflectors. A larger number can enable additional redundancy, which advantageously increases robustness, reduces susceptibility to errors and/or increases accuracy. In this context, a total of 256 reflectors can represent a particularly advantageous compromise between the aforementioned advantages and the complexity of manufacturing and/or the device. It may be provided to arrange the reflectors substantially next to each other, e.g. next to each other in the at least one wing, in order to enable a small installation space, in particular for the required light sources and/or light sensors. It may also be provided to maximize the distance between the reflectors, e.g. distributed over the wings and/or outer ring, in order to optimize robustness, optimize measurement accuracy and/or reduce susceptibility to errors.

It may also be provided to provide at least one opening (preferably, as shown above, a plurality thereof) and at least one reflector (preferably, as shown above, a plurality thereof). This can enable even greater robustness, redundancy and/or accuracy. It may therefore be provided that, in particular in emergency operation, greater accuracy is made possible by combining position detection via (a plurality of) openings and reflectors. In this context, it may be provided to arrange the reflectors and openings substantially next to each other in order to enable a small installation space, in particular for the required light sources and/or light sensors. It may also be provided to maximize the distance between the reflectors and openings in order to optimize robustness, optimize measurement accuracy and/or reduce susceptibility to errors.

It may be provided that at least one (or two) opening(s) and/or at least one (or two) reflector(s) are spaced apart from each other. In this context it may be provided that these are spaced apart in relation to the diameter or radius of the movable element, wherein in particular some are arranged at the outer edge, while the others are arranged closer to the center point. As a result, during rotation, these can be located on tracks that are located further inward and/or outward. This can reduce the probability of failure (of all elements). This can increase safety.

It may be provided that at least one opening and/or one reflector is/are provided in the at least one wing. This can simplify manufacturing, as the component only needs to be machined at the outermost end, for example during punching. At the same time, a position detection located further outward (in relation to the diameter) can have increased accuracy, in particular as a rotation angle can be transferred to a greater distance.

Alternatively or additionally, it may be provided that at least one opening and/or one reflector is/are provided in the at least one wing and at least one reflector and/or one opening is/are provided in the inner ring. This enables spatial separation for the different physical measurement principles, which can optimize robustness and/or susceptibility to errors.

Alternatively or additionally, it may be provided that at least one opening and/or one reflector is/are provided in the at least one wing and at least one reflector and/or one opening is/are provided in the outer ring. This enables spatial separation for the different physical measurement principles, which can optimize robustness and/or susceptibility to errors. In addition, it may be provided that the outer ring and the inner ring (and/or at least one wing) are electrically insulated from each other. This can (additionally) optimize robustness and/or susceptibility to errors.

Safety can be further increased by the measurement device, in particular the more different physical measurement principles are used. Inductive and optical position detection is particularly preferable, as these are particularly robust against common cause failures, in particular since common cause failures that interfere with the inductive measurement principle are less likely to interfere with the optical measurement principle and vice versa.

In this context it may be provided that the optical measurement principle is provided via an optical path for emergency operation and/or fallback operation. Accordingly, in the event of at least a partial failure of the inductive measurement principle, the optical measurement principle can be used. This can be done with reduced resolution, in particular to enable a high level of robustness and/or information for the driver (see above).

Within the scope of the invention, it may be provided that the movable element, in particular the inner ring, has at least one wing gap, which is arranged next to the at least one wing, wherein in particular the at least one wing and the at least one wing gap are arranged at an outwardly facing edge of the inner ring. At least one wing gap can be filled by the outer ring.

A plurality of wings and wing gaps can alternate, preferably evenly along the circumference. It may be provided that the wings and the wing gaps each cover the same angle, e.g. three wings can be provided as well as three wing gaps which each cover 60°. This enables particularly good symmetry, which can facilitate simple manufacturing and/or symmetrical rotation during operation.

In this context, it may be provided that the movable element has a total of wings and/or wing gaps of between 1 and 100, preferably between 1 and 50, preferably between 2 and 20, particularly preferably between 3 and 9, advantageously between 4 and 6, ideally 5. A larger number of wings may increase measurement accuracy. A smaller number of wings may optimize costs, robustness and/or manufacturing.

It may be preferable to select the number of wings and/or wing gaps depending on the rotational movement to be detected. For example, in the case of a butterfly valve, a maximum angle of 90° can be measured between two end positions. This can be made possible, for example, by a movable element with three wings arranged 120° apart. In this way, the 90° range of movement can be sufficiently covered (by sensors). In particular, this can prevent ambiguity in the one or more (angular) positions detected and/or determined. The (angular) resolution and/or (angular) coverage can be increased by increasing the number of wings.

A wing can preferably have at least one opening in order to advantageously shape the induced electrical currents in order to generate a stronger and/or characteristic measurement signal. This enables a particularly advantageous combination of the two measurement principles.

An inductive sensor signal can be provided by the at least one wing and/or the induction detecting element (in particular their interaction), which is provided to the control unit, for example via a data connection.

It is also conceivable that the movable element, the inner ring, the at least one wing, the at least one wing gap and/or the outer ring are designed to be symmetrical, in particular rotationally symmetrical, wherein the center point of the inner ring, in particular an axis of rotation coupled thereto (oriented along the z-direction), preferably serves as the axis of symmetry/point of symmetry. This can enable a particularly advantageous, in particular smooth-running, rotational behavior, which can lead to a particularly accurate measurement. Alternatively or additionally, it may be provided that the movable element, the inner ring, the at least one wing, the at least one wing gap and/or the outer ring are manufactured from a stamped part. This can result in particularly simple, robust, cheap, precise and/or fast manufacturing. In addition, the movable element can be designed to be particularly robust. Preferably, at least two, preferably all physical measurement principles can be (at least partially) enabled by a single movable element made from a stamped part. For example, the at least one wing together with at least one opening located therein can enable both an inductive measurement and an optical measurement.

It is also conceivable that the at least one wing is designed to be angled in relation to the inner ring, wherein in particular the at least one wing is arranged substantially perpendicular to the inner ring.

The at least one wing can substantially point along the axis of rotation (in particular along the z-direction), which can advantageously reduce and/or optimize the installation space. This can also provide a more advantageous arrangement of the induction detecting element and/or counter-measurement device, which can thus be arranged further apart and/or at an angle to each other. As a result, it may be provided to install connection cables for data connection in a bundled and/or space-saving manner. Preferably, all wings can be angled substantially identically. This allows for simpler manufacturing and/or improved, in particular more uniform, rotational behavior. The installation space can be reduced by arranging a corresponding induction detecting element closer to a center point and/or symmetry point or symmetry axis. This allows the installation space in the x-y plane to be reduced. This enables a design that is better adapted to the available installation space. In this case, the measurement device may be arranged in the at least one wing.

Within the scope of the invention, it is optionally possible for the movable element to have at least two wings for inductive position detection of the movable element, in particular to enable redundant inductive position detection.

The functionality of inductive position detection can still be enabled even if one or all but one of the wings no longer generate an (inductive) measurement signal. In addition, the induced measurement signal, in particular signal strength (such as voltage level) and/or signal curve, can be influenced by the number, orientation, position, spacing, thickness, shape, and/or material, and preferably taken into account in advance (during development). This also ensures that the measurement signal is unambiguous, preferably in order to avoid ambiguities when detecting and/or determining the (angular) position.

Here, it may be provided that the movable element and/or the position sensor has at least two induction detecting elements. It may also be provided that the number of wings and the number of induction detecting elements are identical, whereby advantageously each wing generates a sensor signal, in particular a measurable and/or evaluable sensor signal, when approaching and/or moving away from an induction detecting element. This allows additional redundancy to be achieved. Greater robustness and/or lower susceptibility to errors can be achieved.

Furthermore, within the scope of the invention, it may be provided that the measurement device is designed with at least double redundancy based on a further physical measurement principle for detecting the position of the moving element.

This can be realized, for example (as described above), by combining the optical measurement principle with the inductive measurement principle. This can also be realized by further combinations (see below).

In relation to the present invention, it is conceivable that the measurement device enables magnetic and/or capacitive position detection of the movable element.

Accordingly, the one further and/or the further physical measurement principles can enable magnetic and/or capacitive position detection. Safety can be further increased, in particular the more different physical measurement principles are used.

The inner ring, the outer ring and/or at least one wing can have a magnetic material at least in sections. The position sensor can have at least one magnetic sensor element that detects an approach to and/or moving away from the magnetic material. The magnetic material can have holes that are detected by the magnetic sensor element. Particularly preferably, the at least one opening may be used to provide both an optical path and a hole. This can result in a particularly advantageous combination of the different measurement principles. In interaction with the holes, the magnetic sensor element can detect a (periodically) changed magnetic resistance; in particular, the resulting differences in the magnetic flux can be detected electrically. A corresponding additional (magnetic) sensor signal can be generated, which can be transmitted to a control unit via data transmission, for example. The additional sensor signal can comprise a voltage and/or current signal, which can be more robust, particularly against common cause failures affecting the inductive measurement principle. Alternatively or additionally, it may also be provided for the at least one magnetic sensor element to detect at least one opening in the movable element. This enables a particularly space-saving combination, in particular between optical and magnetic position detection. It may also be provided that, depending on the application, either optical or magnetic position detection can be carried out with one (same) movable element. Accordingly, the same movable elements can be used universally. It is possible to integrate the magnetic sensor element for sensing a moving element, in particular a rotating moving element, on a printed circuit board. It may be provided that the latter has a magnet which, for example, is overmolded with corresponding electronic connections and/or is manufactured at least as a single unit.

The inner ring, the outer ring and/or at least one wing can have a capacitor, a capacitor plate and/or a dielectric at least in sections. The position sensor can have at least one capacitive sensor element, for example a plate capacitor the plates of which are preferably arranged above and below (in the z-direction) the moving element, which detects an approach to and/or moving away from the capacitor, the capacitor plate and/or the dielectric. A corresponding further sensor signal can be generated, which can be transmitted to a control unit via data transmission, for example.

The above object is further achieved according to a second aspect by a position sensor according to the invention for position detection, in particular for a steer-by-wire system for a vehicle, having: a movable element; an induction detecting element for inductively detecting movement of the movable element; a counter-measurement device for further detecting a movement of the movable element, in interaction with a measurement device based on a further physical measurement principle for detecting the position of the movable element.

In this context the position sensor may have at least one brush, which is preferably designed to remove dirt from the moving element. This can increase robustness and/or reduce susceptibility to errors. In this context, the at least one brush may preferably be stationary, while the moving element moves relative to the brush, in particular rotates. In this context, the at least one brush may clean the movable element from below and/or above (e.g., relative to the z-direction). Preferably, dust particles in the order of 0.1 mm can be removed. Contamination of the wings, opening and/or reflector can therefore be prevented. It is also advantageous to prevent the adhesion of soiling which, in particular over a longer period of time, impairs the inductive and/or optical position detection, for example by oxidizing agents, which are preferably removed by the brush. Preferably, the brush is arranged in such a way that it cannot touch the at least one reflector when the movable element rotates. This allows the reflective properties of the reflector to be retained.

It may be provided that the position sensor is at least partially integrated on a printed circuit board. Here, for example, the at least one reflector can be arranged on the printed circuit board and, in particular, generate a further (optical) sensor signal together with at least one opening in the movable element. Preferably, the light source and/or the light sensor can be integrated on the printed circuit board. The position sensor can have a housing which preferably comprises a window through which an optical path can preferably be realized. This allows for encapsulation that can still be translucent. It may be provided for the light source and/or the light sensor to be arranged on the back of the printed circuit board and for the light to be guided through a hole or milling in the printed circuit board, for example. This allows the installation space to be minimized and/or specifically designed.

This results in the same advantages with regard to a position sensor according to the invention as have already been described with regard to a movable element according to the invention.

The above object is further achieved according to a third aspect by a method according to the invention for a position sensor for detecting the position of a movable element of the position sensor, in particular for a steer-by-wire system for a vehicle, comprising: providing a position sensor according to the second aspect comprising a movable element according to the first aspect; moving, in particular by operating a steer-by-wire system, the movable element, in particular by coupling the movable element to an axis of rotation of a steer-by-wire system; inductively detecting the movement of the moving element by the position sensor to provide an inductive sensor signal; further detecting the movement of the movable element by the position sensor, in particular a measurement device, in order to provide a further sensor signal based on a further physical measurement principle for detecting the position of the movable element; providing the inductive sensor signal and the further sensor signal to a control unit, preferably via a (respective) data connection; processing the inductive sensor signal and the further sensor signal by the control unit to provide an output signal; providing the output signal by the control unit, for example for operating a steer-by-wire system.

The output signal can have a position, in particular an angular position, a rotational position and/or rotational speed. For example, the control unit can adjust the steering angle of the wheels of a vehicle depending on the output signal via the steer-by-wire system. Alternatively or additionally, it may be provided for the control unit to adjust a steering angle of a control console, for example a steering wheel, of a vehicle as a function of the output signal via the steer-by-wire system.

This results in the same advantages with regard to a method according to the invention as have already been described with regard to a movable element according to the invention and/or a position sensor according to the invention.

The above object is further achieved according to a fourth aspect by a computer program product according to the invention, comprising commands which, when the computer program product is executed by a computer, cause the computer to implement the method according to the third aspect.

This results in the same advantages with respect to a computer program product according to the invention as have already been described with respect to a movable element according to the invention and/or a position sensor according to the invention and/or a method according to the invention.

The above object is further achieved according to a fifth aspect by a computer-readable data carrier according to the invention, in which commands are stored which, when executed by a computer, cause the computer to perform the method according to the third aspect.

This results in the same advantages with respect to a computer-readable data carrier according to the invention as have already been described with respect to a movable element according to the invention and/or a position sensor according to the invention and/or a method according to the invention and/or a computer program product according to the invention.

The above object is further achieved according to a sixth aspect by a control unit according to the invention, comprising a computing unit and a memory unit in which commands are stored which, when at least partially executed by the computing unit, perform a method according to the third aspect.

The control unit can also be used, for example, to control and/or regulate a drive device of a steer-by-wire system of a vehicle, in particular as a function of the sensor signal. It may also be provided to provide the sensor signal to further control units of the vehicle to enable further processing.

The control unit can have an integrated circuit (e.g. ASIC) and/or can be connected thereto for data communication. It may be provided that the sensor signals, in particular optical sensor signals, are transmitted directly to and/or processed by the integrated circuit for an optimized, in particular faster and/or real-time calculation.

The control unit can be configured to perform position detection and/or evaluation depending on (all) incoming sensor signals. In particular, a decision can be made as to which sensor signals are correct and which, in particular, are incorrect. Thus, for example, each physical measurement principle can be designed with at least two channels of redundancy. A redundancy architecture can be described as “2+2”. This allows a “2-out-of-3” decision to be made if a sensor signal provides incorrect and/or faulty information, e.g. a position (angular position). A 2+2 safety architecture can cause 2 different inductive sensor signals and 2 undisturbed optical position sensors without synchronization errors in the event of a common mode failure. A system decision between wrong and right can easily be made in such a case. Even in the example of a common cause failure on the optical position sensors and no influence on the inductive position sensors, a clear wrong-to-right decision can be made unambiguously.

This results in the same advantages with respect to a control unit according to the invention as have already been described with respect to a movable element according to the invention and/or a position sensor according to the invention and/or a method according to the invention and/or a computer program product according to the invention and/or a computer-readable data carrier according to the invention.

The above object is further achieved according to a seventh aspect by a vehicle according to the invention comprising a control unit according to the sixth aspect and/or a position sensor according to the second aspect and/or a movable element according to the first aspect.

This results in the same advantages in relation to a vehicle according to the invention as have already been described in relation to a movable element according to the invention and/or a position sensor according to the invention and/or a method according to the invention and/or a computer program product according to the invention and/or a computer-readable data carrier according to the invention and/or a control unit according to the invention.

### BRIEF DESCRIPTION OF THE DRAWINGS

Further advantages, features and details of the invention are apparent from the following description, in which several exemplary embodiments of the invention are described in detail with reference to the drawings. The drawings show in each case schematically:

FIG. 1 is a movable element with adjacent measurement devices;

FIG. 2 is a movable element with opposing measurement devices;

FIG. 3 is a movable element, openings and reflectors;

FIG. 4 is a movable element, an induction detecting element and a counter-measurement device;

FIG. 5 is a movable element (internal rotor);

FIG. 6 is a movable element (external rotor);

FIG. 7 is a vehicle comprising a position sensor; and

FIG. 8 is a method for a position sensor.

In the following figures, identical reference signs are used for the same technical features, even in different exemplary embodiments.

### DETAILED DESCRIPTION OF THE CURRENT EMBODIMENTS

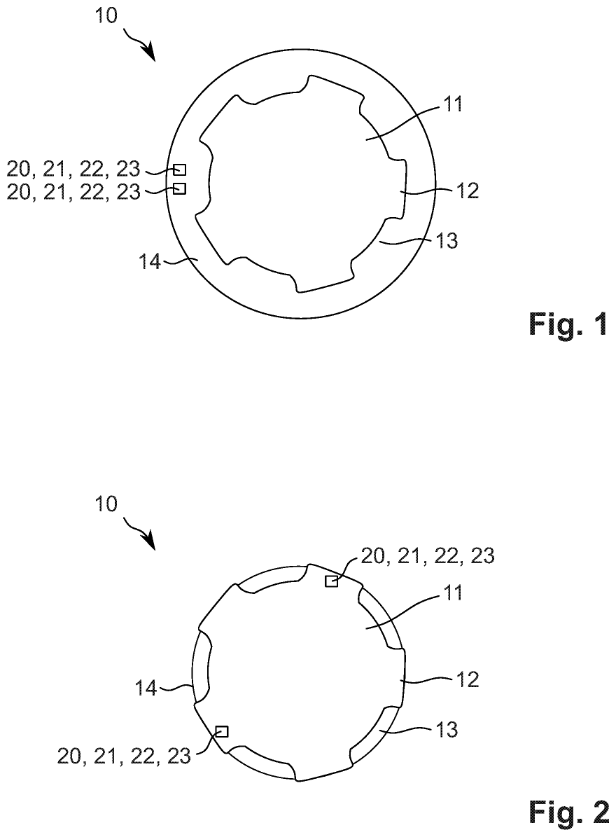

FIG. 1 shows an example of a movable element 10 for a position sensor 100, in particular for a steer-by-wire system 201 for a vehicle 200, having: an inner ring 11 comprising at least one wing 12 for inductively detecting the position of the movable element 10; and a measurement device 20 based on a further physical measurement principle for detecting the position of the movable element 10.

Here, the movable element 10 can be circular, in particular due to the shape of the outer ring 14. Wing gaps 13 can be arranged next to a wing 12, in particular between two wings 12. The measurement device 20 can have an optical path 21, wherein in particular an opening 22, which in particular forms a translucent recess in the movable element 10, and/or a reflector 23, which in particular is designed to reflect light, is/are comprised.

FIG. 2 shows an example of a movable element 10 in the style of FIG. 1. Here, however, the positions of the (two) measurement devices 20 are changed. A first measurement device 20 can be arranged at one end of the movable element 10, while a second measurement device 20 can be arranged at a substantially opposite end of the movable element 10. Here, the diameter of the outer ring 14 is changed so that it is substantially flush with the wings 12. Alternatively or additionally, an arrangement of the measurement device 20 can also be provided in the outer ring 14. This allows separation, in particular electrical separation, between the inner ring 11 or the wings 12 and the outer ring 14, and thus in particular the measurement device 20.

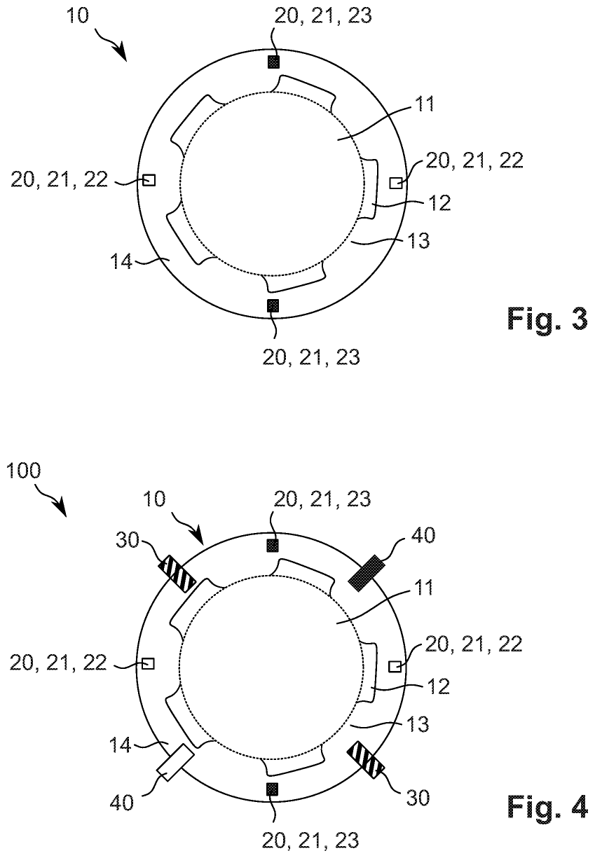

FIG. 3 shows a movable element 10 in the style of FIG. 1 and FIG. 2. Here, (two) openings 22 are shown opposite each other. Here, (two) reflectors 23 are shown opposite each other. The openings 22 and reflectors 23 can be arranged alternately, for example at 90° intervals. This allows the distance to be maximized in order to achieve a particularly high level of robustness. Furthermore, the measuring accuracy can be improved as a result. It is also indicated that the inner ring 11 can be circular, and in particular that the at least one wing 12 or the wings 12 are arranged on its outer edge, for example in a material-locking manner. The inner ring 11 and the wings 12 can thus form a stamped part, for example made of metal.

FIG. 4 shows a movable element 10 in the style of FIG. 1, FIG. 2 and FIG. 3. In addition, a position sensor 100 is shown, which comprises the movable element 10. The position sensor 100 can have at least one induction detecting element 30. As an example, two induction detecting elements 30 are shown, which are located opposite each other in relation to the movable element 10. Here, the induction detecting element 30 can have an inductive encoder. This allows the distance between them to be maximized, which advantageously enables greater robustness and/or more accurate measurement. The position sensor 100 can have at least one counter-measurement device 40. As an example, two counter-measurement devices 40 are shown, which are located opposite each other in relation to the movable element 10. This allows the distance between them to be maximized, which advantageously enables greater robustness and/or more accurate measurement. Accordingly, the induction detecting element 30 and/or the counter-measurement device 40 can each be designed with dual redundancy. Advantageously, at least two different physical measurement principles (e.g. inductive and optical) can be used to enable the position of the movable element 10, and thus in particular of an axis of rotation coupled centrally to the movable element 10, e.g. of a steer-by-wire system 201, to be detected. This ensures a particularly high level of robustness, emergency operation and/or improved safety. As described above, it may also be provided that the at least one wing 12 is designed to be angled, for example by being angled upwards by 90° (and in particular projecting out of the plane of drawing).

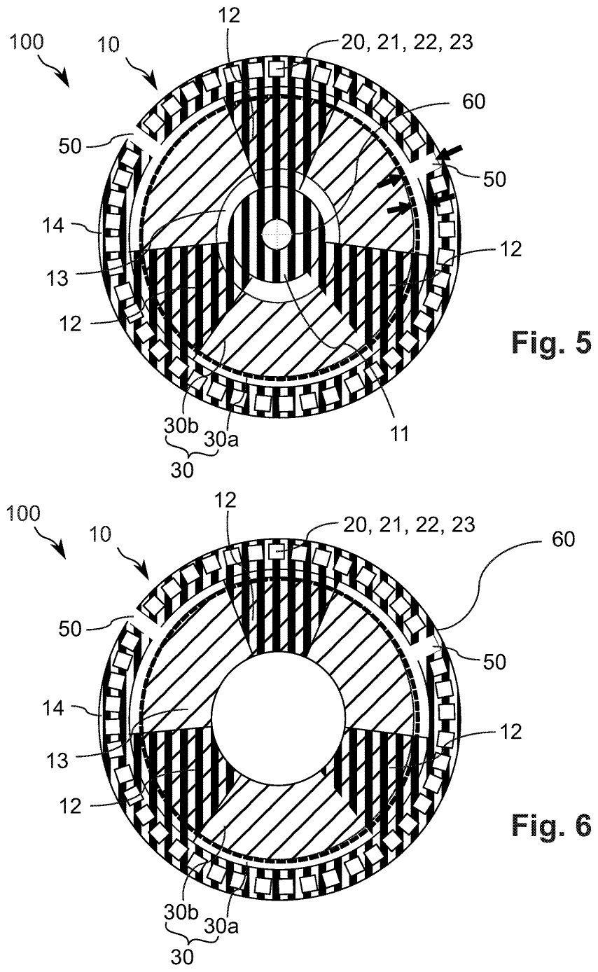

FIG. 5 shows an example of a movable element 10 for a position sensor 100, in particular for a steer-by-wire system 201 for a vehicle 200, having an inner ring 11 comprising three wings 12 for inductively detecting the position of the movable element 10. Here, the three wings 12 are arranged on the inner ring 11 and on the outer ring 14, and together they form a stamped part. Here, the movable element 10 can be circular, in particular due to the shape of the outer ring 14. A wing gap 13 can be arranged next to a wing 12, in particular between two wings 12. The outer ring 14 comprises a plurality of measurement devices 20. Here, the measurement device 20 can have an optical path 21, wherein in particular an opening 22, which in particular forms a translucent recess in the movable element 10, and/or a reflector 23, which in particular is designed to reflect light, is/are comprised. In the present case, these are arranged substantially equidistantly along the outer ring 14. In addition to an optical measurement principle, an inductive measurement principle can also be implemented. Here, an induction detecting element 30 can be provided, which has a transmitting coil 30a (dashed circle) and at least one receiving coil 30b (diagonally hatched). These preferably do not rotate with the other components shown and/or can be arranged separately, in particular planar, e.g. in a plane located below or above, in particular in a printed circuit board (PCB). Preferably, the transmitting coil 30a can emit a transmitting signal, e.g. a high-frequency electromagnetic wave, which induces an eddy current in at least one, preferably all, wings 12. The eddy current(s) can be detected accordingly by the receiving coil 30b. This allows a measurement signal to be measured which is dependent on the (angular) position of the wing(s) 12. The (angular) position can be determined from the measurement signal. It may be provided that the outer ring 14 has at least one slot 50. The slot can form a complete interruption in the material of the outer ring 14. As a result, eddy currents generated by the induction detecting element 30, in particular a transmitting coil 30a, cannot flow (at this point) in the outer ring 14, which in particular enables a more accurate measurement. It may be provided that the slot 50 only partially interrupts the width of the outer ring (in particular in the radial direction). This allows eddy currents to be at least partially prevented, while at the same time the remaining part of the outer ring still provides good mechanical stability. As a result, as shown by the arrows, the distance of the current path of the eddy currents can be at least further away from the induction detecting element 30, in particular the receiving coil 30b, which can in particular enable a more precise measurement and thus determination of the (angular) position of the at least one wing 12. The at least one wing 12, the inner ring 11, the outer ring 14 and/or the at least one measurement device 20 can rotate, in particular about a symmetry point in the center. A rotary fastening 60 can be present on a, in particular central, axis of rotation, for example along the circumference of the axis of rotation. In other words, it can be an internal rotor, in particular with internal axle coupling. The induction detecting element 30 can preferably remain stationary, i.e. in particular not rotate.

In the style of FIG. 5, FIG. 6 also shows an example of a movable element 10 for a position sensor 100. Here, however, no inner ring 11 is provided (as an example), and in particular its width can be infinitesimally small. The wings 12 can therefore be connected to the outer ring 14. The outer ring 14 can have, in particular at least in sections, preferably in the radial direction towards the outside, a rotary fastening 60, for example with a motor and/or a gear. In other words, it can be an external rotor, in particular with hollow axle coupling. For example, a bearing can be provided on the outside. It may also be provided in FIG. 5 and/or FIG. 6 that the outer ring 14 merely forms an extension of at least one wing 12. In other words, the slot 50 can be designed to be large enough that sections of the outer ring 14 overlap with the at least one wing 12, making it appear in particular as if there were no outer ring 14. In other words, a design that can be realized without an outer ring 14 (and/or inner ring 11) is also conceivable.

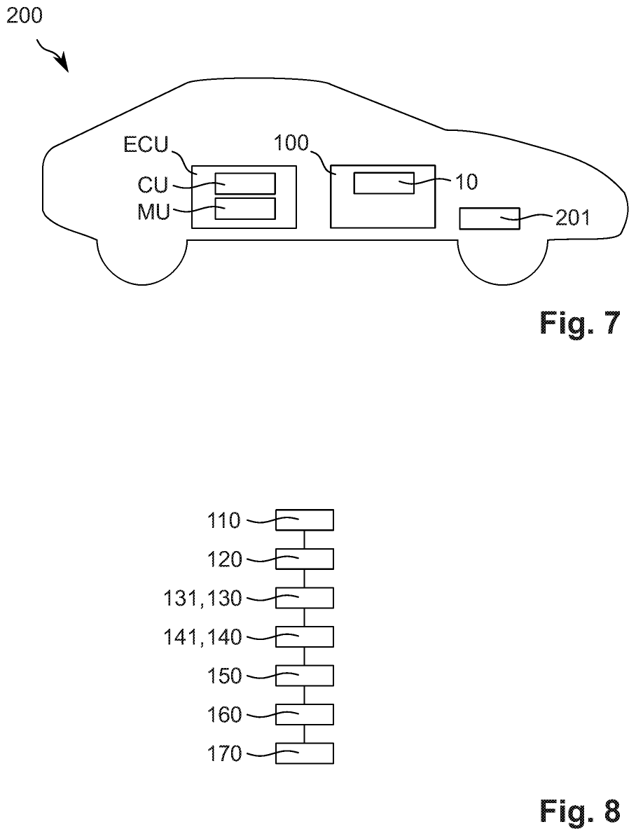

FIG. 7 shows a vehicle 200 comprising a steer-by-wire system 201. Furthermore, the vehicle 200 comprises a control unit ECU comprising a computing unit CU and a memory unit MU. The vehicle 200 may further comprise a position sensor 100 comprising a movable element 10. Here, the position sensor 100 can be integrated in or with the steer-by-wire system 201. Preferably, the position sensor 100 can detect an (angular) position of at least one axis of rotation of the steer-by-wire system 201. Based thereon, the ECU control unit can control and/or regulate the vehicle 200.

FIG. 8 shows a method for a position sensor 100 for detecting the position of a movable element 10 of the position sensor 100, in particular for a steer-by-wire system 201 for a vehicle 200, comprising: providing 110 a position sensor 100, for example according to FIG. 4, comprising a movable element 10, for example according to FIG. 1 to 3; moving 120, in particular by operating a steer-by-wire system 201, the movable element 10; inductively detecting 130 the movement 120 of the movable element 10 by the position sensor 100 to provide an inductive sensor signal 131; further detecting 140 the movement 120 of the movable element 10 by the position sensor 100 in order to provide a further sensor signal 141 based on a further physical measurement principle for detecting the position of the movable element 10; providing 150 the inductive sensor signal 131 and the further sensor signal 141 to a control unit ECU; processing 160 the inductive sensor signal 131 and the further sensor signal 141 by the control unit ECU to provide an output signal; and providing 170 the output signal by the ECU control unit, for example for operating a steer-by-wire system 201.

### LIST OF REFERENCE SIGNS

10 movable element
11 inner ring
12 wings
13 wing gap
14 outer ring
20 measurement device
21 optical path
22 opening
23 reflector
30 induction detecting element
30a transmitting coil
30b receiving coil
40 counter-measurement device
50 slot
60 rotary fastening
100 position sensor
110 providing a position sensor
120 moving the movable element
130 inductively detecting
131 inductive sensor signal
140 further detecting
141 further sensor signal
150 providing the inductive sensor signal
160 processing the inductive sensor signal and the further sensor signal
170 providing the output signal
200 Vehicle
201 steer-by-wire system
CU computing unit
ECU control unit
MU memory unit

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. A movable element for a position sensor, the movable element comprising:
at least one wing configured for inductively detecting a position of the movable element; and
a measurement device based on a further physical measurement principle and configured to detect the position of the movable element.

2. The movable element of claim 1, wherein the movable element comprises at least one of an inner ring or an outer ring on which the at least one wing is arranged, and wherein the outer ring at least partially surrounds the inner ring.

3. The movable element of claim 1, wherein the measurement device comprises at least one optical path configured to optically detect the position of the movable element, wherein the at least one optical path is located at least partially within at least one of an inner ring, the at least one wing, or an outer ring, and wherein the at least one optical path comprises at least one of an opening or a reflector.

4. The movable element of claim 1, wherein the movable element further comprises at least one wing gap arranged adjacent to the at least one wing, and wherein the at least one wing and the at least one wing gap are arranged on an outward-facing edge of an inner ring.

5. The movable element of claim 1, wherein at least one of the movable element, an inner ring, the at least one wing, at least one wing gap, or an outer ring is symmetrical and/or manufactured from a stamped part.

6. The movable element of claim 1, wherein the at least one wing is angled with respect to an inner ring, and wherein the at least one wing is arranged substantially perpendicular to the inner ring.

7. The movable element of claim 1, wherein the movable element comprises at least two wings configured for inductively detecting the position of the movable element to enable redundant inductive position detection.

8. The movable element of claim 1, wherein the measurement device is configured with at least double redundancy based on the further physical measurement principle for detecting the position of the movable element.

9. The movable element of claim 1, wherein the measurement device is configured to enable at least one of magnetic position detection or capacitive position detection of the movable element.

10. A position sensor for position detection, the position sensor comprising:
the movable element according to claim 1;
an induction detecting element configured to inductively detect movement of the movable element; and
a counter-measurement device configured to further detect movement of the movable element in interaction with a measurement device based on a further physical measurement principle for detecting a position of the movable element.

11. A method for detecting a position of a movable element of a position sensor, the method comprising:
providing the position sensor according to claim 10;
moving the movable element;
inductively detecting movement of the movable element by the position sensor to provide an inductive sensor signal;
further detecting movement of the movable element by the position sensor to provide a further sensor signal based on a further physical measurement principle for detecting the position of the movable element;
providing the inductive sensor signal and the further sensor signal to a control unit;
processing the inductive sensor signal and the further sensor signal by the control unit to provide an output signal; and
providing the output signal by the control unit.

12. A computer program product comprising instructions that, when executed by a computer, cause the computer to perform the method of claim 11.

13. A computer-readable data carrier storing instructions that, when executed by a computer, cause the computer to perform the method of claim 11.

14. A control unit comprising:
a computing unit; and
a memory storing instructions that, when executed at least partially by the computing unit, cause the control unit to perform the method of claim 11.

15. A vehicle comprising:
the movable element of claim 1.
